(19) United States
(12) Patent Application Publication
(10) Pub. No.: US 2016/0052804 A1
(43) Pub. Date: Feb. 25, 2016

(54) POROUS MEMBRANE AND WATER PURIFIER

(71) Applicant: TORAY INDUSTRIES, INC., Tokyo (JP)

(72) Inventors: Shiro NOSAKA, Otsu-shi (JP); Yoshiyuki UENO, Otsu-shi (JP); Masahiro OSABE, Otsu-shi (JP)

(73) Assignee: TORAY INDUSTRIES, INC., Tokyo (JP)

(21) Appl. No.: 14/780,275

(22) PCT Filed: Mar. 12, 2014
(86) PCT No.: PCT/JP2014/056475

§ 371 Date: Sep. 25, 2015

(30) Foreign Application Priority Data
Mar. 28, 2013 (JP) 2013-068389

(51) Int. Cl. C02F 1/44; B01D 61/02; B01D 69/02; C02F 1/00

(52) U.S. Cl. CPC C02F 1/442; C02F 1/003; B01D 61/027; B01D 69/02; C02F 2303/04; B01D 2325/02

(57) ABSTRACT

The present invention addresses the problem of providing a porous membrane for a water purification purpose, which can be used even under high water pressures and which has both virus-removing performance and water permeability. The problem can be solved as follows: a porous membrane is provided, wherein the average pore shorter-axis diameter in one surface is smaller than that in the other surface, and in a cross section of the membrane in the thickness direction, the pore diameters increase from one surface toward the other surface to have at least one maximum value and then decrease. The membrane has a layer which is provided on the side of the surface having a larger average pore shorter-axis diameter and which has pore diameters of 130 nm or less in the cross section of the membrane, wherein the layer has a thickness of 0.5 to 20 μm inclusive and the layer has pores each having a pore diameter of 100 to 130 nm inclusive.

### TECHNICAL FIELD

The present invention relates to a porous membrane and a water purifier including a porous membrane. Specifically, the present invention relates to a porous membrane which can be used suitable for a virus-removing purpose.

### BACKGROUND ART

A porous membrane is suitable for membrane separation in which substances in a liquid are size-excluded depending on the size of a pore in the porous membrane, and has been used in a wide variety of use applications including medical applications such as hemodialysis and hemofiltration, water treatment applications such as home-use water purifiers and water purification treatment, and food production processes such as sterilization of foods and beverages and concentration of fruit juices.

Particularly in the field of home-use water purifiers, for the purpose of avoiding the risk of contaminating drinking water with viruses and bacteria in districts and developing countries where water supply and sewerage systems are not fully equipped, home-use water purifiers which have virus-removing performance have been demanded. Among viruses which may have the risk of being contaminated into drinking water, norovirus can cause food poisoning through oral infection. In food poisoning caused by norovirus, it is often difficult to identify the source of infection. In many cases, drinking water is suspected to be the cause of the food poisoning. Norovirus has a size as small as 38 nm. The removal of a substance by a porous membrane relies on the size of the substance. Therefore, the smaller the size of the substance is, the more the substance removing performance of the porous membrane decreases. Furthermore, norovirus is extremely infectious, and a human can be infected with a small amount, e.g., 10 to 100 cells, of the virus. Therefore, for avoiding the occurrence of food poisoning, high removing performance is required for a porous membrane.

That is, a porous membrane which can remove a substance having a size of 38 nm or more at a removal ratio of 99.99% or higher has been demanded in home-use water purifiers.

Heretofore, home-use water purifiers in each of which a porous membrane is used to remove impurities have been used widely. In the water purifier, the substances to be removed are malodorous substances and bacteria contained in tap water, and activated carbon and a microfiltration membrane are mainly used as filtrating materials. However, activated carbon has poor virus-adsorbing performance, and the targets of a microfiltration membrane are bacteria and iron rust each having a diameter of 100 nm or larger. Therefore, viruses having a diameter of 38 nm cannot be removed by activated carbon or a microfiltration membrane.

When the sizes of pores in a porous membrane are decreased for the purpose of removing viruses, the water permeability of the porous membrane decreases, which is a serious problem in applications of home-use water purifiers which are required to produce a large volume of water within a short time. Virus-removing performance and water permeability, which are properties required for a porous membrane, are greatly influenced by the pore diameters in the surface of the porous membrane, and there is such a mutually contradictory relationship between virus-removing performance and water permeability that virus-removing performance increases but water permeability decreases when the diameters of the pores are small.

Furthermore, in application of home-use water purifiers, a porous membrane is used under a tap water pressure, and is therefore required to have a membrane structure that can resist a high water pressure.

The structure of a porous membrane is roughly classified into two types: a uniform structure in which the pore diameters do not vary substantially in the thickness direction of the membrane; and a nonuniform structure in which the pore diameters vary continuously or discontinuously and the pore diameters in one surface, the pore diameters in the inside and the pore diameters in the other surface are different. In the nonuniform structure, a layer having smaller pore diameters, which contributes to size exclusion, is thin, and therefore water permeation resistance is small and water permeability is high. Among the nonuniform structures, a membrane having fine pore structure of both sides, in which the pore diameters increase from one surface toward the other surface to have at least one maximum value and then decrease, is disclosed in Patent Literatures 1 to 4.

### CITATION LIST

### Patent Literatures

Patent Literature 1: Japanese Patent Application Publication Laid-open No. 9-47645

Patent Literature 2: Japanese Unexamined Patent Application Publication (Translation of PCT Application) No. 7-506496

Patent Literature 3: Japanese Patent Application Publication Laid-open No. 2007-289886

Patent Literature 4: Japanese Unexamined Patent Application Publication (Translation of PCT Application) No. 11-506387

### SUMMARY OF THE INVENTION

### Technical Problems

Patent Literature 1 discloses a porous membrane which has a fine pore structure of both sides, in which the pore diameters in a layer near one surface are 500 nm or less and are 0.6 time or more and less than 1.2 times larger than the pore diameters in a layer near the other surface. With regard to the structure of the porous membrane, a cross section of the membrane in the thickness direction is divided into 10 layers and attention is focused on an inner wall side and an outer wall side of each of the layers and on a pore diameter that is the maximum value. However, the thickness of each of the layers is not taken into consideration. With respect to the determination of removing performance, the removing performance is evaluated under a water pressure as low as 6.7 kPa, and there is no statement about removing performance as measured using the porous membrane in filtration under a high water pressure.

Patent Literature 2 discloses a porous membrane which has a fine pore structure of both sides, in which the pore diameters in both surfaces cannot be observed at a magnification of 10000 times. With respect to the structure of the porous membrane, only the diameters in surfaces are mentioned and there is no statement about the thickness of a layer having smaller pore diameters. With respect to the determination of removing performance, the removing performance is evaluated under a water pressure as low as 27 kPa, and there is no statement about removing performance as measured using the porous membrane in filtration under a high water pressure.

Patent Literature 3 discloses a porous membrane which has a fine pore structure of both sides, in which there are few pores each having a larger diameter than a particle diameter exclusion limit of fine particles in the inner surface of the membrane, and in which the maximum value of pore diameters appears at a position closer to the inner surface side relative to the center in a cross section of the membrane in the thickness direction. With respect to the structure of the porous membrane, attention is focused on the levels of porosities of 8 layers which are produced by dividing a cross section of the membrane in the thickness direction. However, the pore diameters in each of the layers and the thicknesses of the layers are not taken into consideration. With respect to removing performance, the removing performance is evaluated under a water pressure as high as 150 kPa, but the performance of removing particles each having a diameter of 50 nm is as low as about 75%. Therefore, it is assumed that the ratio of removal of viruses having a diameter of 38 nm would be further poorer.

Patent Literature 4 discloses a porous membrane which has a fine pore structure of both sides, in which there are a layer that has a separation limit of 500 to 5000000 daltons and a layer that has larger pore diameters and does not affect the separation limit. With respect to the structure of the porous membrane, attention is focused on the pore diameters in a cross section of the membrane in the thickness direction and the thickness of the porous membrane. However, a layer located on a side having larger pore diameters has pore diameters that do not affect the separation limit of the porous membrane, and therefore it is assumed that the layer does not contribute to the improvement in removing performance. With respect to the determination of removing performance, the removing performance is evaluated under a water pressure as low as 20 kPa, and there is no statement about removing performance as measured using the porous membrane in filtration under a high water pressure.

According to the knowledge of the present inventors, for the production of a porous membrane that can exhibit high virus-removing performance as measured using the porous membrane in filtration under a high water pressure, the thickness of a layer which has pore diameters contributing to the removal of viruses is important with respect to the structure of the porous membrane. In all of the prior arts, statement was made only about pore diameters. Up to now, there is no porous membrane in which attention is focused on both the pore diameters and the thickness and which can achieve both virus-removing performance and water permeability when used under a high water pressure.

An object of the present invention is to provide a porous membrane which can achieve both virus-removing performance and water permeability when used under a high water pressure.

### Means for Solving Problem

For the purpose of solving the above-mentioned problems, the present invention provides a porous membrane as mentioned below.

(1) A porous membrane having properties below:

(A-1) an average pore shorter-axis diameter in one surface is smaller than that in another surface;

(A-2) in a cross section of the membrane in the thickness direction, pore diameters increase from the one surface toward the other surface to have at least one maximum value and then decrease;

(A-3) the porous membrane has a layer of a layer which is provided on a side of a surface having a larger average pore shorter-axis diameter and which has pore diameters of 130 nm or less, the layer extending in the thickness direction from the surface, wherein a thickness of the layer is 0.5 to 20 μm inclusive; and

(A-4) the layer has pores each having a pore diameter of 100 to 130 nm inclusive.

As a preferred embodiment of the porous membrane and a use method for the porous membrane, the present invention provides the porous membrane and the use method mentioned below.

(2) The porous membrane according to the above-mentioned item, wherein the porous membrane further has a property below:

(A-5) the average pore shorter-axis diameter is 10 to 50 nm inclusive in a surface of a side where the average pore shorter-axis diameter is small.

(3) The porous membrane according to any one of the above-mentioned items, wherein the porous membrane further has a property below:

(A-6) an average pore longer-axis diameter in the surface of the side where the surface has a smaller average pore shorter-axis diameter is 2.5 times or more larger than the average pore shorter-axis diameter in the surface of the side where the surface has a smaller average pore shorter-axis diameter.

(4) The porous membrane according to any one of the above-mentioned items, wherein the porous membrane further has properties below:

(A-7) the porous membrane has a layer which is provided on the side of the surface having a smaller average pore shorter-axis diameter and which has pore diameters of 130 nm or less, the layer extending from the surface, wherein a thickness of the layer is 0.3 to 20 μm inclusive; and

(A-8) the layer has pores each having a pore diameter of 100 to 130 nm inclusive.

(5) The porous membrane according to any one of the above-mentioned items, wherein the porous membrane further has a property below:

(A-9) in a cross section of the membrane in the thickness direction, an part extending to a thickness of 3 μM from the surface of the side where the surface has a smaller average pore shorter-axis diameter has a porosity of 5 to 35% inclusive.

(6) The porous membrane according to any one of the above-mentioned items, wherein the porous membrane further has a property below:

(A-10) the surface of the side where the surface has a smaller average pore shorter-axis diameter has an opening ratio of 0.7 to 12% inclusive.

(7) The porous membrane according to any one of the above-mentioned items, wherein the porous membrane further has a property below:

(A-11) an overall porosity of the porous membrane is 60 to 90% inclusive.

(8) The porous membrane according to any one of the above-mentioned items, wherein the porous membrane further has a property below:

(A-12) a maximum pore diameter in the cross section of the membrane in the thickness direction is 10 μm or less.

(9) The porous membrane according to any one of the above-mentioned items, wherein a structure of the membrane is an integral structure.

(10) The porous membrane according to any one of the above-mentioned items, wherein the porous membrane is a hollow fiber membrane.

(11) The porous membrane according to the above-mentioned items, wherein an average pore shorter-axis diameter in an inner surface is smaller than that in an outer surface in the hollow fiber membrane.

(12) The porous membrane according to any one of the above-mentioned items, wherein a thickness of the membrane is 60 to 200 μm inclusive and a (thickness)/(inner diameter) ratio is 0.35 to 1.00 inclusive.

(13) A method for purifying water, comprising the step of allowing water to permeate the porous membrane according to any one of the above-mentioned items from a side of a surface having a larger average pore shorter-axis diameter toward a side of a surface having a smaller average pore shorter-axis diameter.

The present invention also provides a porous membrane as mentioned below.

(14) A porous membrane having properties below:

(B−1) an average pore shorter-axis diameter in one surface is smaller than that in another surface;

(B-2) an average pore longer-axis diameter in a surface of a side where the surface has a smaller average pore shorter-axis diameter is 2.5 times or more larger than an average pore shorter-axis diameter in the surface of the side where the surface has a smaller average pore shorter-axis diameter;

(B-3) in a cross section of the membrane in the thickness direction, a part extending to a thickness of 3 μm from the surface of the side where the surface has a smaller average pore shorter-axis diameter has a porosity of 5 to 35 inclusive; and

(B-4) the surface of the side where the surface has a smaller average pore shorter-axis diameter has an opening ratio of 0.7 to 12% inclusive.

As a preferred embodiment of the porous membrane and a use method for the porous membrane, the present invention provides the porous membrane and the use method mentioned below.

(15) The porous membrane according to the above-mentioned item, wherein the porous membrane further has properties below:

(B-5) in a cross section of the membrane in the thickness direction, pore diameters increase from the one surface toward the other surface to have at least one maximum value and then decrease;

(B-6) the porous membrane has a layer which is provided on a side of a surface having a larger average pore shorter-axis diameter and which has pore diameters of 130 nm or less, the layer extending in the thickness direction from the surface, wherein a thickness of the layer is 0.5 to 20 μm inclusive; and

(B-7) the layer has pores each having a pore diameter of 100 to 130 nm inclusive.

(16) The porous membrane according to claim 14 or 15, wherein the porous membrane further has a property below:

(B-8) the average pore shorter-axis diameter is 10 to 50 nm inclusive in a surface of a side where the average pore shorter-axis diameter is small.

(17) The porous membrane according to any one of the above-mentioned items, wherein the porous membrane further has properties below:

(3-9) the porous membrane has a layer which is provided on the side of the surface having a smaller average pore shorter-axis diameter and which has pore diameters of 130 nm or less, the layer extending from the surface, wherein a thickness of the layer is 0.3 to 20 μm inclusive; and

(B-10) the layer has pores each having a pore diameter of 100 to 130 nm inclusive.

(18) The porous membrane according to any one of the above-mentioned items, wherein the porous membrane further has a property below:

(B-11) an overall porosity of the porous membrane is 60 to 90% inclusive.

(19) The porous membrane according to any one of the above-mentioned items, wherein the porous membrane further has a property below:

(B-12) a maximum pore diameter in the cross section of the membrane in the thickness direction is 10 μm or less.

(20) The porous membrane according to any one of the above-mentioned items, wherein a structure of the membrane is an integral structure.

(21) The porous membrane according to any one of the above-mentioned items, wherein the porous membrane is a hollow fiber membrane.

(22) The porous membrane according to the above-mentioned items, wherein an average pore shorter-axis diameter in an inner surface is smaller than that in an outer surface in the hollow fiber membrane.

(23) The porous membrane according to any one of the above-mentioned items, wherein a thickness of the membrane is 60 to 200 μm inclusive and a (thickness)/(inner diameter) ratio is 0.35 to 1.0 inclusive.

(24) A method for purifying water, comprising the step of allowing water to permeate the porous membrane according to any one of the above-mentioned items from a side of a surface having a larger average pore shorter-axis diameter toward a side of a surface having a smaller average pore shorter-axis diameter.

The porous membrane according to the present invention is used for the below-mentioned purpose.

(25) The porous membrane according to any one of the above-mentioned items, wherein the porous membrane is used for a virus-removing purpose.

The present invention provides a water purifier as mentioned below.

(26) A water purifier including the porous membrane according to any one of the above-mentioned items.

(27) The water purifier according to the above-mentioned item, wherein a raw water flow path is disposed on the side of the surface having a larger average pore shorter-axis diameter, and a permeated water flow path is disposed on the side of the surface having a smaller average pore shorter-axis diameter.

In the present invention, a scanning electron microscope is referred to as “SEM”.

### Effect of the Invention

According to the present invention, as explained below, a porous membrane can be provided which can exhibit both virus-removing performance and water permeability when used under a high water pressure. For example, when the porous membrane is included in a home-use water purifier, the water purifier can be excellent in compactness, and safe water having pathogenic viruses removed therefrom can be produced in a large quantity within a short time.

### BRIEF DESCRIPTION OF THE DRAWINGS

FIG. 1 shows a SEM image of the entire of a cross section, which is taken in the thickness direction, of a porous membrane produced by the method of Example 1.

FIG. 2 shows a SEM image of the outer surface side of the cross section, which is taken in the thickness direction, of the porous membrane produced by the method of Example 1.

FIG. 3 shows a binarized image of the SEM image of the outer surface side of the cross section, which is taken in the thickness direction, of the porous membrane produced by the method of Example 1.

FIG. 4 shows a binarized image of the SEM image of the outer surface side of the cross section, which is taken in the thickness direction, of the porous membrane produced by the method of Example 1, in which pores each having a pore diameter of 130 nm or more are identified.

FIG. 5 shows a SEM image of the inner surface of the porous membrane produced by the method of Example 1.

FIG. 6 shows a binarized image of the SEM image of the inner surface of the porous membrane produced by the method of Example 1.

FIG. 7 shows a SEM image of the outer surface of the porous membrane produced by the method of Example 1.

FIG. 8 shows a SEM image of the inner surface side of the cross section, which is taken in the thickness direction, of the porous membrane produced by the method of Example 1.

FIG. 9 shows a binarized image of the SEM image of the inner surface side of the cross section, which is taken in the thickness direction, of the porous membrane produced by the method of Example 1.

### MODE FOR CARRYING OUT THE INVENTION

The present inventors have made intensive studies. As a result, the present inventors have found that a porous membrane having the below-mentioned properties can exhibit high virus-removing performance and high water permeability when used under a high water pressure:

the average pore shorter-axis diameter in one surface is smaller than that in the other surface; and in a cross section of the membrane in the thickness direction, the pore diameters increase from the one surface toward the other surface to have at least one maximum value and then decrease;

the porous membrane has a layer which is provided on a side of a surface having a larger average pore shorter-axis diameter and which has pore diameters of 130 nm or less, the layer extending in the thickness direction from the surface, wherein a thickness of the layer is 0.5 to 20 μm inclusive; and the layer has pores each having a pore diameter of 100 to 130 nm inclusive.

The present inventors have also found that a porous membrane having the below-mentioned properties can exhibit high virus-removing performance and high water permeability when used under a high water pressure:

the average pore shorter-axis diameter in one surface is smaller than that in the other surface;

the average pore longer-axis diameter in the surface of the side where the surface has a smaller average pore shorter-axis diameter is 2.5 times or more larger than the average pore shorter-axis diameter in the surface of the side where the surface has a smaller average pore shorter-axis diameter;

in a cross section of the membrane in the thickness direction, a part extending to a thickness of 3 μm from the surface of the side where the surface has a smaller average pore shorter-axis diameter has a porosity of 5 to 35% inclusive; and

the surface of the side where the surface has a smaller average pore shorter-axis diameter has an opening ratio of 0.7 to 12% inclusive.

When water containing viruses is filtrated through a porous membrane, if water pressure is high, virus-removing performance of the porous membrane tends to decrease. This is considered to be because the pressure applied onto the pores in the surface of the porous membrane increases, and therefore, the pores are expanded and the shorter diameters of the pores are enlarged. When water is allowed to flow from the side of the surface having a larger average pore shorter-axis diameter, the thickness of a dense layer provided on the side of the surface having a larger average pore shorter-axis diameter is increased. Accordingly, the pressure loss produced at the time of the passing of water through the dense layer increases, a pressure to be applied onto the surface of the side where the surface has a smaller average pore shorter-axis diameter, which greatly contributes to the removal of viruses, decreases, and therefore, the enlargement of the shorter axes of the pores in the surface is prevented.

Furthermore, viruses can also be removed through a dense layer provided on the side of the surface having a larger average pore shorter-axis diameter. Therefore, depth filtration, by which viruses can be removed in a step-by-step manner in the thickness directions in the dense layers, can occur. For achieving a high level, i.e., 99.99%, of virus-removing performance through only one surface, it is required to form small pores having a small variation in pore diameters. In this case, however, the control of the pore diameters is difficult and water permeability significantly decreases. Then, a dense layer having pore diameters that can contribute to the removal of viruses is provided on the side of the surface having a larger average pore shorter-axis diameter in the porous membrane, thereby causing the depth filtration in the dense layer to remove viruses at a level of several tens percentage. As a result, a high level of virus-removing performance is not required for the surface of the side where the surface has a smaller average pore shorter-axis diameter, the variation in pore diameters can be accepted, and the pore diameters can be increased. Accordingly, water permeability can be made high. Norovirus, which can be contaminated into drinking water to cause gastroenteritis, has a diameter of 38 nm. The maximum pore diameter that can contribute to the removal of norovirus having a diameter of 38 nm is about 130 nm. Therefore, in the present invention, a layer which is provided on the side of the surface having a larger average pore shorter-axis diameter and which contains pores each having a pore diameter of 130 nm or less is referred to as “dense layer (I)”. If the dense layer contains only pores having small pore diameters, the water permeability of the membrane is significantly decreased. Therefore, it is necessary to provide the dense layer (I) at least on the side where pores have larger pore diameters. When the membrane is used under a high water pressure, for the purpose of increasing both virus-removing performance and water permeability, it is required to adjust the thickness of the layer, which is provided on the side of the surface having a larger average pore shorter-axis diameter and which contains pores each having a pore diameter of 130 nm or less, to 0.5 μm or more, more preferably 3 μm or more. On the contrary, if the dense layer (I) is too thick, water permeability is decreased. Therefore, it is required to adjust the thickness of the dense layer (I) to 20 μm or less, preferably 15 μm or less. It is also required for the layer having pore diameters of 130 nm or less to have pores each having a pore diameter of 100 to 130 nm inclusive.

The dense layer (I) may be in contact with the surface. Alternatively, a region in which pores have larger pore diameters than those in the dense layer (I) may be arranged between the dense layer (I) and the surface. Particularly on the side on which the porous membrane is in contact with another porous membrane or the porous membrane is in contact with a case member, it is preferred to arrange the region in which pores have larger pore diameters than those in the dense layer (I) between the dense layer (I) and the surface, because the pore diameters in the surface is increased and therefore friction force to be applied onto the surface is decreased, leading to the improvement of the insertion property of the porous membrane into a case or the improvement of handling property of the porous membrane.

When the porous membrane is used under a high water pressure, for the purpose of satisfactorily achieving the effect of improving virus-removing performance, it is effective to reduce the water pressure to be applied onto the side of the surface having a larger pore shorter-axis diameter and to also reduce the water pressure to be applied onto the surface of the side where the surface has a smaller average pore shorter-axis diameter. For these reasons, it is preferred to allow water to permeate the porous membrane from the side of the surface having a larger average pore shorter-axis diameter toward the side of the surface having a smaller average pore shorter-axis diameter.

That is, in a water purification method using the porous membrane according to the present invention, it is preferred to dispose a raw water flow path on the side of the surface having a larger average pore shorter-axis diameter and to dispose a permeated water flow path on the side of the surface having a smaller average pore shorter-axis diameter in the porous membrane.

For improving virus-removing performance of the porous membrane, it is effective to also provide a dense layer which can contribute to the removal of viruses (the dense layer is referred to as “dense layer (II)”, hereinafter) on the side of the surface having a smaller average pore shorter-axis diameter. It is preferred that the thickness of the layer, which is provided on the side of the surface having a smaller average pore shorter-axis diameter and which has pore diameters of 130 nm or less, is 0.3 μm or more. On the contrary, if the dense layer (II) is too thick, water permeability is decreased. Therefore, it is required to adjust the thickness of the dense layer (II) to preferably 20 μm or less, more preferably 10 μm or less. If the dense layer (II) contains only pores having small pore diameters, the water permeability of the membrane is significantly decreased. Therefore, it is preferred that the layer having pore diameters of 130 nm or less has pores each having a pore diameter of 100 to 130 nm inclusive.

The thicknesses of the dense layers can be measured from an image of a cross section of the porous membrane which is observed on a SEM. The pores in the cross section have infinite forms. Therefore, the area of each of the pores is measured by processing the image, and the diameter of a circle equivalent to the area is determined as a pore diameter. Pores each having a pore diameter of 130 nm or more are identified, and the thickness of a layer, which contains no pore having the above-mentioned pore diameter as observed in the thickness direction, from the surface is measured.

For the purpose of increasing the thicknesses of the dense layers, it is effective to increase the concentration of a polymer mainly constituting the membrane in a membrane formation stock solution to decrease the pore diameters in the entire of the porous membrane, or to increase the viscosity of a membrane formation stock solution to prevent the growth of pores which may be caused by phase separation, or to accelerate the coagulation of the membrane formation stock solution to decrease the pore diameters.

Since the porous membrane can sieve substances to be removed depending on the sizes of the pores, the virus-removing performance of the porous membrane depends on the shorter-axis diameters of the pores. In the size sieving through the pores, pores that are larger than the actual pore diameters can achieve the effect. Therefore, when norovirus having a diameter of 38 nm is removed satisfactorily, the average pore shorter-axis diameter in the surface of the side where the surface has a smaller average pore shorter-axis diameter is preferably 50 nm or less, more preferably 38 nm or less. From the viewpoint of the variation in shorter-axis diameters, the average pore shorter-axis diameter is more preferably 30 nm or less. On the other hand, if the average pore shorter-axis diameter in the surface is too small, the water permeability of the porous membrane significantly decreases. Therefore, the average pore shorter-axis diameter is preferably 10 nm or more, more preferably 15 nm or more.

The virus-removing performance of the porous membrane can be improved by considering not only the average value of the pore shorter-axis diameters in the surface but also the variation in the pore shorter-axis diameters. When the variation in pore shorter-axis diameters is decreased, the number of large pores through which viruses can pass can be decreased and the virus-removing performance can be improved. The standard deviation of the pore shorter-axis diameters in the surface of the side where the surface has a smaller average pore shorter-axis diameter is preferably 30 nm or less, more preferably 15 nm or less. For the purpose of decreasing the standard deviation of the pore shorter-axis diameters in the surface, a method can be employed in which the weight average molecular weight distribution of a hydrophilic polymer, which is added as a pore-forming agent, is decreased to uniformize the size of a layer that is formed as a result of phase separation as much as possible. It is also effective to draw the membrane during or after the production of the membrane to enlarge the pores present in the surface. When the pores present in the surface are enlarged, larger pores tend to be deformed. Therefore, when the amount of deformation of pores is increased, the shorter-axis diameters or larger pores become smaller and the shorter-axis diameters of smaller pores change little, resulting in the reduction of variation in shorter-axis diameters.

A porous membrane which can exhibit both high virus-removing performance and high water permeability when used under a high water pressure can be produced by forming the dense layer (I) arranged on the side of the surface having a larger average pore shorter-axis diameter into the above-mentioned configuration. Furthermore, a porous membrane having higher water permeability can be produced by increasing the pore longer-axis diameters in the surface having a smaller average pore shorter-axis diameter. Since viruses can be removed by the shorter-axis diameters of pores, the resistance of permeation of water can be reduced to improve water permeability without altering the virus removal ratio through an increase in longer-axis pore diameters. The larger the average longer-axis diameter is compared with the average pore shorter-axis diameter, the more water permeability can be improved while keeping virus-removing performance at a high level. On the other hand, when the pores have such shapes that the average longer-axis diameter and the average shorter-axis diameter are small, i.e., the pores become almost circular, the structural strength of the pores can be improved and the pore shorter-axis diameters in the surface can be prevented from being enlarged due to a high water pressure.

For these reasons, it is preferred that the average pore longer-axis diameter in the surface is 2.5 times or more, more preferably 3.0 times or more, larger than the average pore shorter-axis diameter. From the viewpoint of the strength of the membrane structure, it is preferred that the average pore longer-axis diameter in the surface is 10 times or less, more preferably 8 times or less, particularly preferably 5 times or less larger than the average pore shorter-axis diameter.

As the method for increasing the average pore longer-axis diameter in the surface compared with the average pore shorter-axis diameter, a method of drawing the pores is effective. The method includes a draw method of drawing the pores after coagulating the porous membrane and a method of increasing a draft ratio and drawing the pores before the coagulation of the porous membrane. The method of increasing a draft ratio is preferred, because the method can be applied widely without limiting the method for forming the porous membrane or limiting the type of a material for forming the membrane. The draw method cannot be applied when the strength of the porous membrane is not high. Therefore, a crystalline polymer is preferably used as a material for forming the membrane.

The term “draft ratio” refers to a value obtained by dividing a take-up speed of a porous membrane by a linear discharge speed through a slit. The term “linear discharge speed” refers to a value obtained by dividing a discharge flow amount by the cross-sectional area of the slit. For increasing the draft ratio, a method of increasing the take-up speed; a method of increasing the cross-sectional area of the slit; and a method of decreasing the discharge flow amount can be employed. A method by which the draw ratio can be increased without altering the shape of the porous membrane and the cross-sectional area of the slit can be increased is preferred. In the method of increasing the take-up speed and the method of decreasing the discharge flow amount, the cross-sectional area of the porous membrane is decreased, and therefore, the deterioration in physical strength of the porous membrane may occur.

The shorter-axis diameter and the longer-axis diameter of each pore in the surface can be measured from an image of the surface which is observed on a SEM. The shorter-axis diameter refers to the longest diameter as observed in the shorter axis direction, and the longer-axis diameter refers to the longest diameter as observed in the longer axis direction. Among pores which can be confirmed on a SEM at a magnification of 50000 times, the number of all of pores which are present in a 1 μm×1 μm square is counted. When the total number of the measured pores is less than 50, the counting in a 1 μm×1 μm square is repeated until the total number of the measured pores becomes 50 or more, and resultant date are added. From the results of the measurement, an average value and a standard deviation are calculated.

The number of flow paths for water increases and the water permeability increases when the opening ratio in the surface of the side where the surface has a smaller average pore shorter-axis diameter is high. On the contrary, when the opening ratio is decreased, the structural strength of the surface increases and the pore shorter-axis diameters in the surface can be prevented from being enlarged due to a high water pressure. For these reasons, the opening ratio in the surface of the side where the surface has a smaller average pore shorter-axis diameter is preferably 0.7% or more, and is also preferably 12% or less, more preferably 6% or less.

For increasing the opening ratio, it is effective to increase the amount of the hydrophilic polymer to be added to the membrane formation stock solution.

The opening ratio in the surface can be determined from an image of the porous membrane surface which is observed on a SEM. An image observed at a magnification of 10000 times is processed and then subjected to a binary coded processing, wherein a structural part has a light brightness value and a pore part has a dark brightness value. Subsequently, the percentage of the area of the dark brightness value relative to the measured area is calculated and is employed as an opening ratio.

The strength in the vicinity of a pore in the surface increases when the porosity in the surface of the side where the surface has a smaller average pore shorter-axis diameter and the porosity in the vicinity of the surface are small, and the enlargement of the shorter-axis diameters of pores in the surface due to a high water pressure can be prevented. On the contrary, the number of flow paths for water increases when the porosity in the surface and the porosity in the vicinity of the surface are high, and therefore water permeability increases. For these reasons, in a cross section of the membrane in the thickness direction, a part extending to a thickness of 3 μm from the surface of the side where the surface has a smaller average pore shorter-axis diameter has a porosity of preferably 5% or more, more preferably 10% or more. On the other hand, the porosity is also preferably 35% or less, more preferably 30% or less.

As the method of decreasing the porosity in the part extending to a thickness of 3 μm from the surface of the side where the surface has a smaller average pore shorter-axis diameter, a method of increasing the concentration of a polymer, which forms the structure of the porous member, in the membrane formation stock solution; a method of increasing the viscosity of the membrane formation stock solution; and a method of increasing the coagulation rate during the production of the membrane are effective.

When the overall porosity of the porous membrane is high, the water permeation resistance decreases and the water permeability increases. On the contrary, when the overall porosity of the porous membrane is low, the strength of the porous membrane increases and the structure is hard to be broken easily even under a high water pressure. For these reasons, the overall porosity of the porous membrane is preferably 60% or more, more preferably 70% or more, and is also preferably 90% or less.

The overall porosity of the porous membrane is a percentage value of the volume of pores relative to the apparent volume of the porous membrane which is expressed by a dimension. The overall porosity can be calculated from the apparent volume which is calculated from the dimension of the porous membrane and the true volume of the porous membrane which is calculated from the weight and specific gravity of the porous membrane.

From the viewpoint of the strength of the porous membrane, the maximum pore diameter in the cross section of the membrane in the thickness direction is preferably 10 μm or less, more preferably 3 μm or less.

The polymer which forms the structure of the porous membrane is not particularly limited, and a polysulfone-type polymer is preferably used, because the polymer has high mechanical strength and high selective permeability. The polysulfone-type polymer to be used in the present invention is preferably one having an aromatic ring, a sulfonyl group and an ether group in the main chain thereof, and for example, polysulfones represented by the following chemical formulas (1) and (2) are suitably used. However, the polysulfones are not limited thereto in the present invention. In the formulas, n represents an integer of, for example, 50 to 80.

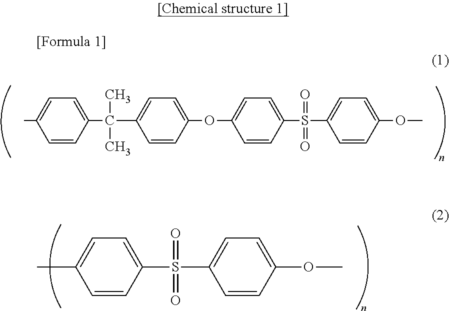

Specific examples of the polysulfone include polysulfones such as “Udel” (registered trade mark) polysulfone P-1700 and P-3500 (manufactured by Solvay Corp.), “Ultrason” (registered trade mark) S3010 and 56010 (manufactured by BASF), “VICTREX” (registered trade mark) (manufactured by Sumitomo Chemical Co., Ltd.), “RADEL” (registered trade mark) A (manufactured by Solvay Corp.) and “Ultrason” (registered trade mark) E (manufactured by BASF). As the polysulfone to be used in the present invention, a polymer composed only of a repeating unit represented by the formula (1) and/or (2) is preferably used. However, as long as the effect of the present invention is not disturbed, the repeating unit may be copolymerized with other monomer. Without any limitation, the other copolymerizable monomer is preferably contained in an amount of 10% by mass or less.

The porous membrane can be produced by inducing phase separation in a membrane formation stock solution, which is prepared by dissolving a polymer that forms the structure of the porous membrane in a solvent, with heat or a poor solvent and then removing the solvent component. The polymer dissolved in the solvent has high mobility, and therefore, can coagulate at the time of the phase separation to increase the concentration thereof, thereby forming a dense structure. A membrane having such a structure that the pore diameters are different as observed in the thickness direction can be produced by altering the rate of the phase separation in the thickness direction.

When a hydrophilic polymer is added to the membrane formation stock solution, the hydrophilic polymer is contained in the porous membrane, thereby increasing water wettability and water permeability. Therefore, the hydrophilic polymer is preferably contained in the porous membrane in an amount of 1.5% by mass or more. On the other hand, if the content of the hydrophilic polymer in the porous membrane is too high, the amount of eluted matters increases. Therefore, the amount of the hydrophilic polymer is preferably 8% by mass or less.

It is required that the method for determining the content of the hydrophilic polymer is selected depending on the kind of the polymer. However, the content of the hydrophilic polymer can be determined by a method such as an elemental analysis method.

Non-limiting specific examples of the hydrophilic polymer include polyethylene glycol, polyvinylpyrrolidone, polyethyleneimine, polyvinyl alcohol and derivatives thereof. The hydrophilic polymer may be copolymerized with other monomer.

The hydrophilic polymer may be selected properly depending on the affinity with the polymer that forms the structure of the porous membrane or the solvent. When the structure of the porous membrane is composed of a polysulfone-type polymer, polyvinylpyrrolidone is preferably used because of its high compatibility with the polysulfone-type polymer.

As the form of the porous membrane, a hollow fiber membrane is preferred, because a hollow fiber membrane has a larger membrane surface area per volume and a hollow fiber membrane having a large surface area can be housed compactly. The hollow fiber membrane can be produced by flowing an injection solution or an injection gas through a circular tube in a double-tube nozzle spinneret to discharge a membrane formation stock solution through an outer slit. In this case, the structure of the inner surface of the hollow fiber membrane can be controlled by varying the concentration of a poor solvent in the injection solution, the temperature of the injection solution or the temperature of the injection gas. For the purpose of easily controlling the structure of the surface of the side where the average pore shorter-axis diameter is small, the structure having great influence on virus-removing performance, it is preferred that the average pore shorter-axis diameter in the inner surface of the hollow fiber membrane is smaller than the average pore shorter-axis diameter in the outer surface of the hollow fiber membrane.

The thickness of the porous membrane is properly selected depending on the pressure to be applied during the intended use. When the porous membrane is used in a water purifier, the thickness of the porous membrane is preferably 60 μm or more, more preferably 80 μm or more, so as to resist the pressure of tap water. On the other hand, the water permeation resistance decreases and the water permeability increases when the thickness of the porous membrane is small. Therefore, the thickness of the porous membrane is preferably 200 μm or less, more preferably 150 μm or less.

When the porous membrane is a hollow fiber membrane, the pressure resistance of the membrane is in correlation with the ratio of the thickness of the membrane to the inner diameter of the membrane, and the pressure resistance becomes higher when the ratio of the thickness to the inner diameter (thickness/inner diameter) is larger. When the inner diameter of the membrane is reduced, the size of a water purifier including the porous membrane can be reduced and the pressure resistance of the porous membrane can be improved. However, for reducing the inner diameter of the membrane, it is required to narrow the membrane during the production of the membrane. In this case, the resultant membrane may be in the form of a star-shaped fiber in which wrinkles are formed on the inner wall thereof. In such a star-shaped fiber, the phase separation occurs nonuniformly, resulted in the unevennesses of pore diameters and the deterioration in virus-removing performance. For reducing the size of a water purifier and improving the virus-removing performance, water permeability and pressure resistance, the thickness of the hollow fiber membrane is preferably 60 μm or more, more preferably 80 μm or more. The thickness is also preferably 200 μm or less, more preferably 150 μm or less. The (thickness)/(inner diameter) ratio of the hollow fiber membrane is preferably 0.35 or more. The (thickness)/(inner diameter) ratio of the hollow fiber membrane is also preferably 1.0 or less, more preferably 0.7 or less.

The porous membrane according to the present invention has high virus-removing performance and high water permeability, and therefore can be used suitably in use applications in a virus-removing purpose. The porous membrane can also be used suitably in use applications in which a large volume of water is to be treated within a short time, such as a porous membrane to be included in a water purifier.

When dense layers are formed in both surfaces of the porous membrane, as the method for controlling the thickness of each of the dense layers, a method can be mentioned, which includes controlling the formation of pores by phase separation occurring in the both surfaces to form an integral membrane structure in which the pore diameters vary continuously. Another method includes forming at least two layers having different materials or different compositions from each other to produce a composite membrane. A porous membrane having an integral membrane structure does not have a structural part which is a layer-layer interface and therefore is brittle compared with a composite membrane, and the structure of the porous membrane is hardly broken even under a high water pressure. For these reasons, it is preferred that the membrane structure is an integral structure.

Without any limitation, the porous membrane according to the present invention is produced by discharging a membrane formation stock solution through a slit, allowing the discharged stock solution to pass through a dry unit, and then coagulating the passed stock solution in a coagulating bath.

When the phase separation is to be induced with heat, the membrane formation stock solution is cooled in the dry unit and then rapidly cooled in a coagulating bath to coagulate the stock solution. When the phase separation is to be induced with a poor solvent, the membrane formation stock solution is discharged while allowing the stock solution to be in contact with a coagulation solution containing the poor solvent and is then coagulated in a coagulating bath composed of the poor solvent. In the method of inducing the phase separation with the poor solvent, the poor solvent is supplied by means of diffusion and therefore the amount of the poor solvent to be supplied in the thickness direction varies. As a result, the resultant porous membrane has such a structure that the pore diameters increase from one surface toward the other surface as observed in a cross section in the thickness direction. For these reasons, it is preferred that the coagulation solution containing the poor solvent is brought into contact with the membrane formation stock solution immediately after the discharge of the stock solution. Then, the coagulation solution is prepared in the form of a mixed solution including a poor solvent and a good solvent, and the coagulation property can be varied and the pore shorter-axis diameter and the thickness of the dense layer in the surface that is in contact with the coagulation solution can be controlled by adjusting the concentration of the poor solvent in the coagulation solution.

On the side where the coagulation solution is in contact with the membrane formation stock solution, the phase separation is induced and coagulation proceeds rapidly, thereby forming a dense structure having smaller pore diameters. The pore diameters continuously increase toward the opposite side. If the time required for passing through the dry unit is too long, the pores on the side where the coagulation solution is not in contact with the membrane formation stock solution grow too large. Then, the time for passing through the dry unit is shortened and the membrane formation stock solution is immersed in the coagulation solution rapidly. In this case, the coagulation on the side where the coagulation solution is not in contact with the membrane formation stock solution proceeds by the contact with the poor solvent in the coagulation bath, thereby forming a dense structure having small pore diameters.

The time for passing the membrane formation stock solution through the dry unit depends on conditions that affect the progression of the phase separation, e.g., the composition and temperature of the membrane formation stock solution, and is preferably 0.02 seconds or longer, more preferably 0.14 seconds or longer. On the other hand, the time is also preferably 0.40 seconds or shorter, more preferably 0.35 seconds or shorter.

The growth of pores proceeds gradually from the side where the stock solution is in contact with the coagulation solution toward the thickness direction. Therefore, this is effective to increase the thickness of the membrane and to form a dense structure on the side where the stock solution is not in contact with the coagulation solution.

When the discharge temperature of the membrane formation stock solution is decreased, the diffusion rate of the poor solvent that serves as the coagulation solution is also decreased, and therefore the growth of pore diameters on the side where the membrane formation stock solution is not in contact with the coagulation solution can be prevented. For this reason, the discharge temperature of the membrane formation stock solution is preferably 470° C. or lower, more preferably 50° C. or lower. On the other hand, the condensation of the membrane formation stock solution on the surface of the spinneret can be prevented by increasing the discharge temperature of the membrane formation stock solution. Therefore, the discharge temperature of the membrane formation stock solution is preferably 20° C. or higher.

The coagulation rate of the membrane formation stock solution can be increased by increasing the concentration of the poor solvent in the coagulating bath or lowering the temperature of the coagulating bath. Therefore, this is effective to form a dense structure on the side where the membrane formation stock solution is not in contact with the coagulation solution.

The concentration of the poor solvent in the coagulating bath is preferably 30% by mass or more, more preferably 50% by mass or more, still more preferably 80% by mass or more. The temperature of the coagulating bath is preferably 70° C. or lower, more preferably 50° C. or lower. On the other hand, when the temperature of the coagulating bath is high, the solvent exchange can occur easily in the coagulating bath and the amount of the solvent remaining on the porous membrane can be reduced. Therefore, the temperature of the coagulating bath is preferably 10° C. or higher, more preferably 20° C. or higher.

The temperature of the coagulating bath varies over time when the membrane formation stock solution is supplied or the solvent is supplied from the coagulation solution. Therefore, it is preferred that the liquid volume in the coagulating bath is increased to prevent the change in concentration of the poor solvent, or the concentration of the poor solvent is monitored to adjust the concentration of the poor solvent whenever necessary.

In the dry unit, the phase separation is induced on the side where the membrane formation stock solution is not in contact with the coagulation solution by the action of water contained in air. The amount of water, i.e., poor solvent, to be supplied increases when the dew point in the dry unit is high and the amount of air in the dry unit is large. Therefore, this is effective to form a dense structure on the side where the membrane formation stock solution is not in contact with the coagulation solution. The dew point in the dry unit is preferably 10° C. or higher, more preferably 20° C. or higher. The amount of air in the dry unit is preferably 0.1 m/s or more, more preferably 0.5 m/s or more. On the other hand, when the amount of air in the dry unit is decreased, the irregularity of the surface or shaking of the membrane formation stock solution during the discharge of the membrane formation stock solution can be prevented. Therefore, the amount of air in the dry unit is preferably 10 m/s or less, more preferably 5 m/s or less.

The term “poor solvent” refers to a solvent which cannot dissolve primarily a polymer that forms the structure of the porous membrane at the membrane formation temperature. The poor solvent may be properly selected depending on the kind of the polymer used, and water is suitably used as the poor solvent. The good solvent may be properly selected depending on the kind of the polymer used. When the polymer that forms the structure of the porous membrane is a polysulfone-type polymer, N,N-dimethylacetamide is suitably used as the good solvent.

When the viscosity of the membrane formation stock solution is increased, the growth of pores by the phase separation can be prevented and therefore the thickness of the dense layer is increased. In order to increase the viscosity of the membrane formation stock solution, it can be mentioned as an example that the amount of a polymer that forms the structure of the porous membrane and/or a hydrophilic polymer is mainly increased; a thickening agent is added; and the discharge temperature is lowered. The viscosity of the membrane formation stock solution is preferably 0.5 Pa·s or more, more preferably 1.0 Pa·s or more, at the discharge temperature. The viscosity of the membrane formation stock solution is also preferably 20 Pa·s or less, more preferably 10 Pa's or less.

### EXAMPLES

The present invention will be described below with reference to Examples. However, the present invention is not limited to the Examples.

(1) Measurement of Water Permeability

A measurement example in which the porous membrane is a hollow fiber membrane will be mentioned below.

A hollow fiber membrane was charged in a housing having a diameter of 5 mm and a length of 17 cm in such a manner that the membrane area of the outer surface of the hollow fiber membrane became 0.004 m². The membrane area can be calculated in accordance with the equation shown below.

Membrane area A (m²)=(outer diameter (μm)×π×17 (cm)×(number of fibers)×0.00000001

Both ends of the hollow fiber membrane were potted to each other using an epoxy resin-type chemical reaction-type adhesive agent “QUICK MENDER” (Konishi Co., Ltd.), and the bonded product was cut to open the bonded product, thereby producing a hollow fiber membrane module. Subsequently, the inside and the outside of the hollow fiber membrane in the module were washed with distilled water at 100 ml/min for 1 hour. A water pressure of 13 kPa was applied onto the outside of the hollow fiber membrane, and the filtration amount of water flowing out to the inside of the hollow fiber membrane per unit time was measured. Water permeability (UFR) was calculated in accordance with the equation shown below.

UFR (ml/hr/Pa/m²)=Qw/(P×T×A)

wherein, Qw represents a filtration amount (mL), T represents an outflow time (hr), P represents a pressure (Pa), and A represents the membrane area of the hollow fiber membrane.

(2) Measurement of Virus-Removing Performance

A measurement example in which the porous membrane is a hollow fiber membrane will be mentioned below.

The evaluation was carried out using the module that had been subjected to the evaluation (1)

A virus stock solution was prepared in such a manner that cells of bacteriophage MS-2 (Bacteriophage MS-2 ATCC 15597-B1) each having a size of about 25 nm were added to distilled water so as to have a concentration of about 1.0×10⁷ PFU/ml. As the distilled water, distilled water was used which was produced using a pure water production apparatus “AUTO STILL” (registered trade mark) (manufactured by Yamato Scientific Co., Ltd.) and then sterilized with steam under a high pressure at 121° C. for 20 minutes. The entire volume of the virus stock solution was filtrated by supplying the virus stock solution from the outer surface of the module toward a hollow part in the module under conditions of a temperature of about 20° C. and a predetermined filtration differential pressure. The filtrate was collected in such a manner that 150 ml of a permeated liquid was discarded, then 5 ml of a permeated liquid for measurement was collected, and then the collected permeated liquid was diluted with distilled water at dilution rates of 0, 100, 10000 and 100000. The concentration of bacteriophage MS-2 was determined in accordance with the method of Overlay agar assay, Standard Method 9211-D (APHA, 1998, Standard methods for the examination of water and wastewater, 18th ed.) by seeding 1 ml of each of the diluted permeated liquids onto an assay petri dish and then counting the number of plaques. Plaques are masses of bacteria that were infected with viruses and dead, and can be counted as dot-like plaques. The virus-removing performance was expressed in terms of a log reduction value (LRV) for viruses. For example, LRV of 2 is −log₁₀ x=2, i.e., 0.01, and means the residual concentration of viruses is 1/100 (removal ratio: 99%). When no plaque was counted in a permeated liquid, it means that the permeated liquid has a LRV of 7.0.

The measurement was carried out under filtration differential pressures of 7 kPa and 50 kPa.

By determining the log reduction value for viruses using bacteriophage MS-2, the performance of removing viruses each having a larger diameter and being contaminated with drinking water can be ensured.

(3) Measurement of Pore Diameters of Surface

Each of both surfaces of a porous membrane was observed on a SEM (S-5500, manufactured by Hitachi High-Technologies Corporation) at a magnification of 50000 times, and an image thereof was captured in a computer. The size of the captured image was 640 pixels×480 pixels. When the porous membrane was a hollow fiber membrane and the inside of the hollow fiber was to be observed, the hollow fiber membrane was cut into a semicircular shape to be observed.

The shorter-axis diameter of a pore is the longest diameter as observed in the shorter axis direction, and the longer-axis diameter of a pore is the longest diameter as observed in the longer axis direction. All of pores present in a 1 μm×1 μm area were measured with respect to their shorter-axis diameters and longer-axis diameters. The measurement in a 1 μm×1 μm area was repeated until the total number of pores became 50 or more, and the results were added to data. When two pores were observed overlapped with each other in the depth direction, the exposed part of the pore located at the deeper position was measured. When a portion of a pore was out of the measurement area, the pore was excluded. An average value and a standard deviation were calculated.

(4) Measurement of Opening Ratio on Surface

The surface of a porous membrane was observed on a SEM (S-5500, manufactured by Hitachi High-Technologies Corporation) at a magnification of 50000 times, and an image thereof was captured in a computer. The size of the captured image was 640 pixels×480 pixels. The observation was carried out on the same sample as used in the measurement (3). The SEM image was cut into a 6 μm×6 μm piece and the image analysis of the piece was carried out using image processing software. A threshold value was determined by a binary coded processing in such a manner that a structural part had a light brightness value and other parts than the structural part had a dark brightness value, thereby obtaining an image in which the light brightness region was seen as white and the dark brightness region was seen as black. When the structural part could not be distinguished from the other parts than the structural part due to the contrast difference in the image, areas in which the contrasts were same as each other were cut out, the areas were separately subjected to a binary coded processing, and then the cut areas were put back together to form a single image. Alternatively, the other parts than the structural part may be colored in black and then the resultant image may be analyzed. The image contained noises, and the dark brightness region in which the number of contiguous pixels was 5 or less was regarded as the light brightness region, i.e., the structural part, because the noises and pores could not be distinguished from each other. As the method for eliminating the noises, the dark brightness region in which the number of contiguous pixels was 5 or less was excluded in the counting of the number of pixels. Alternatively, the noise parts may be colored in white. An opening ratio was determined by counting the number of pixels in the dark brightness region and then calculating the percentage of the number of the pixels relative to the total number of pixels in the analyzed image. The measurement was carried out on 10 images and an average value thereof was calculated.

(5) Measurement of Thickness of Dense Layer

A porous membrane was wetted by being immersed in water for 5 minutes and then frozen with liquid nitrogen, and the frozen product was folded rapidly, thereby producing a cross section observation sample. The cross section of the porous membrane was observed on a SEM (S-5500, manufactured by Hitachi High-Technologies Corporation) at a magnification of 10000, and an image thereof was captured in a computer. The size of the captured image was 640 pixels×480 pixels. In the case where pores present in the cross section were closed when observed on the SEM, the preparation of a sample was retried. The closing of the pores may sometimes occur due to the deformation of the porous membrane in the stress direction in the cutting treatment. The SEM image was cut in a direction parallel to the surface of the porous membrane at a length of 6 μm and in the thickness direction at an arbitrary length, and the image of the resultant area was analyzed using image processing software. The length of the area to be analyzed in the thickness direction may be any one as long as a dense layer fits within the length. When a dense layer did not fit within the observation field at a measurement magnification, at least two SEM images were synthesized so as to fit the dense layer within the SEM images. A threshold value was determined by a binary coded processing in such a manner that a structural part had a light brightness value and other parts than the structural part had a dark brightness value, thereby obtaining an image in which the light brightness region was seen as white and the dark brightness region was seen as black. When the structural part could not be distinguished from the other parts than the structural part due to the contrast difference in the image, areas in which the contrasts were same as each other were cut out, the areas were separately subjected to a binary coded processing, and then the cut areas were put back together to form a single image. Alternatively, the other parts than the structural part may be colored in black and then the resultant image may be analyzed. When two pores were observed overlapped with each other in the depth direction, a pore located at a shallower position was measured. When a portion of a pore was out of the measurement area, the pore was excluded. The image contained noises, and the dark brightness region in which the number of contiguous pixels was 5 or less was regarded as the light brightness region, i.e., the structural part, because the noises and pores could not be distinguished from each other. As the method for eliminating the noises, the dark brightness region in which the number of contiguous pixels was 5 or less was excluded in the counting of the number of pixels. Alternatively, the noise parts may be colored in white. The number of pixels in a scale bar which indicated a known length in the image was counted, and the length per pixel was calculated. The number of pixels in the pores was counted, and that number of pixels in the pores was multiplied with the square of the length per pixel to determine the pore area. The diameter of a circle corresponding to the pore area was calculated in accordance with the equation shown below to determine the pore diameter. The pore area corresponding to the pore diameter of 130 nm was 1.3×10⁴ (nm²).

Pore diameter=(pore area÷circular constant)^{0.5}×2

Pores each having a pore diameter of 130 nm or more were identified, a layer in which such pores were not present was defined as a dense layer, and the thickness of the dense layer as observed in the direction perpendicular to the surface of the dense layer was measured. A perpendicular line to the surface was drawn, and the longest distance among the distances between the surface on the perpendicular line and pores each having a pore diameter of 130 nm or more is the thickness of the dense layer. When the dense layer is in contact with the surface, the thickness of the dense layer is the distance between the surface and a pore that is the closest to the surface and has a pore diameter of 130 nm. In one image, the measurement was carried out at five positions. With respect to 10 images, the measurement was carried out in the same manner, and an average value of 50 measurement data was calculated. The presence or absence of pores each having a pore diameter of 100 to 130 nm inclusive in the dense layer was determined.

(6) Measurement of Pore Diameters in Cross Section

The sample produced in (5) was used as an observation sample. The cross section of the porous membrane was observed on a SEM (S-5500, manufactured by Hitachi High-Technologies Corporation) at a magnification of 10000, and an image thereof was captured in a computer. The size of the captured image was 640 pixels×480 pixels. The SEM image was cut in the thickness direction at a length of 5 μm and in a direction parallel to the surface of the porous membrane at a length of 5 μm, and the image of the resultant area was analyzed using image processing software. A threshold value was determined by a binary coded processing in such a manner that a structural part had a light brightness value and other parts than the structural part had a dark brightness value, thereby obtaining an image in which the light brightness region was seen as white and the dark brightness region was seen as black. When the structural part could not be distinguished from the other parts than the structural part due to the contrast difference in the image, the other parts than the structural part were colored in black and then the resultant image was analyzed. When two pores were observed overlapped with each other in the depth direction, a pore located at a shallower position was measured. When a portion of a pore was out of the measurement area, the pore was excluded. The image contained noises, and the dark brightness region in which the number of contiguous pixels was 5 or less was regarded as the light brightness region, i.e., the structural part, because the noises and pores could not be distinguished from each other. As the method for eliminating the noises, the dark brightness region in which the number of contiguous pixels was 5 or less may be colored in white or may be excluded in the counting of the number of the pixels. The number of pixels in a scale bar which indicated a known length in the image was counted, and the length per pixel was calculated. The number of pixels in the pores was counted, and that number of pixels in the pores was multiplied with the square of the length per pixel to determine the pore area. The diameter of a circle corresponding to the pore area was calculated in accordance with the equation shown below to determine the pore diameter.

Pore diameter=(pore area÷circular constant)^{0.5}×2

The measurement was carried out in the same manner so that the entire of the cross section of the membrane in the thickness direction could be observed. An average pore diameter at parts in the cross section was determined, and the largest pore diameter was measured. The measurement was carried out in the same manner at five positions to calculate an average value.

It was determined whether or not the porous membrane had an integral structure in which pore diameters were continuously varied. It was also determined whether or not the porous membrane had such a fine pore structure of both sides that the pore diameters continuously increased from one surface of the porous membrane toward the other surface of the porous membrane to have at least one maximum value and then decreased.

(7) Measurement of Porosity at Depth of 3 μm from Surface as Observed in Cross-Sectional Direction

The sample produced in (5) was used as an observation sample. The cross section of the porous membrane was observed on a SEM (S-5500, manufactured by Hitachi High-Technologies Corporation) at a magnification of 10000, and an image thereof was captured in a computer. The size of the captured image was 640 pixels×480 pixels. The SEM image was cut in the thickness direction at a length of 3 μm and in a direction parallel to the surface of the porous membrane at a length of 5 μm, and the image of the resultant area was analyzed using image processing software. A threshold value was determined by a binary coded processing in such a manner that a structural part had a light brightness value and other parts than the structural part had a dark brightness value, thereby obtaining an image in which the light brightness region was seen as white and the dark brightness region was seen as black. When the structural part could not be distinguished from the other parts than the structural part due to the contrast difference in the image, the other parts than the structural part were colored in black and then the resultant image was analyzed. When two pores were observed overlapped each other in the depth direction, a pore located at a shallower position was measured. The image contained noises, and the dark brightness region in which the number of contiguous pixels was 5 or less was regarded as the light brightness region, i.e., the structural part, because the noises and pores could not be distinguished from each other. As the method for eliminating the noises, the dark brightness region in which the number of contiguous pixels was 5 or less may be colored in white or may be excluded in the counting of the number of the pixels. The number of pixels in the dark brightness region was counted, the percentage thereof relative to the total number of pixels in the image to be analyzed was calculated to determine a porosity. The measurement was carried out in the same manner on 10 images, and an average value was calculated.

(8) Elementary Analysis

A porous membrane (3 g) was lyophilized and then analyzed on full automatic elementary analyzer varioEL (Elementar) at a sample decomposition passage temperature of 950° C., a reduction furnace temperature of 500° C., a helium flow rate of 200 ml/min and an oxygen flow rate of 20 to 25 ml/min. When polysulfone was used as a structure polymer and polyvinylpyrrolidone was used as a hydrophilic polymer, the content (w_{C} (% by mass)) of the hydrophilic polymer was calculated from the content (w_{N} (% by mass)) of nitrogen measured in accordance with the equation shown below.

w_{C}=W_{N}×111/14

(9) Measurement of Overall Porosity of Porous Membrane

A measurement example in which a porous membrane is a hollow fiber membrane will be mentioned below.

A porous membrane was cut into a 10-cm piece in the length direction, and the weight m (g) of the piece was measured. The porosity P (%) in the porous membrane was calculated from the specific gravity a (g/ml) of a material of the porous membrane and the inner radius rᵢ (cm) and the outer radius rₒ (cm) of the porous membrane in accordance with the equation shown below. The measurement was carried out on 10 samples, and an average value was determined.

P=(1−((m÷a)÷((rₒ²×π−rᵢ²×π)×10)))×100.

(10) Pressure Resistance Test

A measurement example in which a porous membrane is a hollow fiber membrane will be mentioned below.

Ten hollow fiber membranes were charged in a housing having a diameter of 5 mm and a length of 17 cm.

Both ends of the hollow fiber membranes were potted with a potting material composed of a polyurethane resin, the resultant product was cut to open the product, thereby producing a hollow fiber membrane module. Subsequently, the hollow fiber membranes of the module and the inside of the module were washed with distilled water at a rate of 100 ml/min for 1 hour. A water pressure of 400 kPa was applied onto the outside of the hollow fiber membrane for 1 minute. The module was dissembled, and it was confirmed with naked eyes whether or not the hollow fiber membranes were crushed.

### Example 1

Polysulfone (manufactured by Solvay Corp., Udel polysulfone (registered trade mark) P-3500) (20 parts by weight) and polyvinylpyrrolidone (manufactured by BASF, K30, weight average molecular weight: 40000) (11 parts by weight) were added to a mixed solvent composed of N,N′-dimethylacetamide (68 parts by weight) and water (1 part by weight), and the resultant mixture was heated at 90° C. for 6 hours to dissolved the components, thereby producing a membrane formation stock solution. The membrane formation stock solution was discharged through a circular slit of a double annular cylindrical spinneret. The outer diameter and the inner diameter of the circular slit were 0.59 mm and 0.23 mm, respectively. As an injection solution, a solution composed of N,N′-dimethylacetamide (70 parts by weight) and water (30 parts by weight) was discharged through an inner tube. The spinneret was kept at 40° C. The discharged membrane formation stock solution was allowed to flow through a dry unit (70 mm), in which a gas having a dew point of 26° C. (temperature: 30° C., humidity: 80%) was allowed to flow at an air flow rate of 2.1 m/s, for 0.11 seconds, and was then introduced into a coagulation bath containing N,N′-dimethylacetamide (95 parts by weight) and water (5 parts by weight) at 40° C. to coagulate the stock solution. The coagulated product was washed with water at 50° C., and was then wound at a speed of 40 m/min to form a skein. The draft ratio was 2.6. The resultant product was cut in a 20-cm piece in the length direction, and the piece was washed with hot water at 80° C. for 5 hours, and was then heated at 100° C. for 2 hours. The amount of discharge of the stock solution and the amount of discharge of the injection solution were controlled, so that a porous membrane having the form of a hollow fiber membrane which had a fiber inner diameter of 180 μm and a thickness of 90 μm after heat treatment was produced.

The porous membrane was subjected to the measurement of water permeability, the measurement of virus-removing performance, the measurement of pore shorter-axis diameters in surface, the measurement of opening ratio of surface, the measurement of thickness of dense layer, the elementary analysis, the measurement of pore diameters on cross section, the measurement of porosity in part extending to depth of 3 μm from surface as observed in cross-sectional direction, the measurement of porosity, and the pressure resistance test. The results are shown in Table 1.

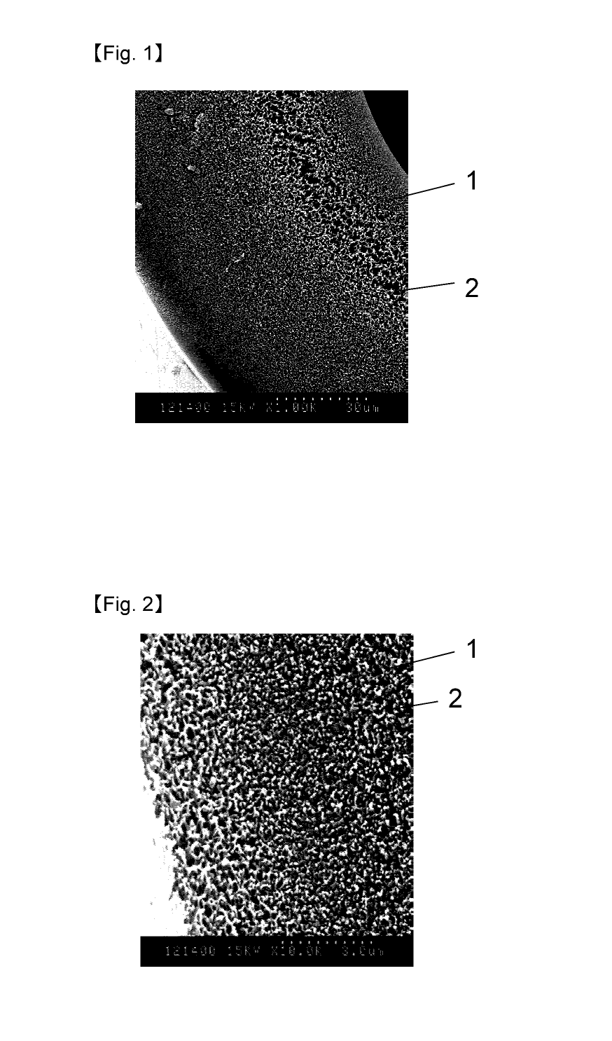

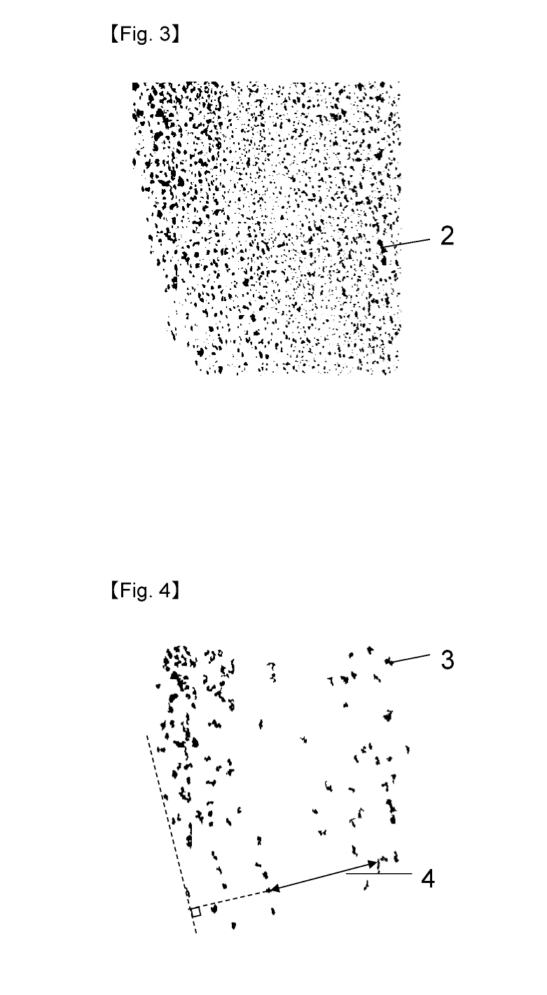

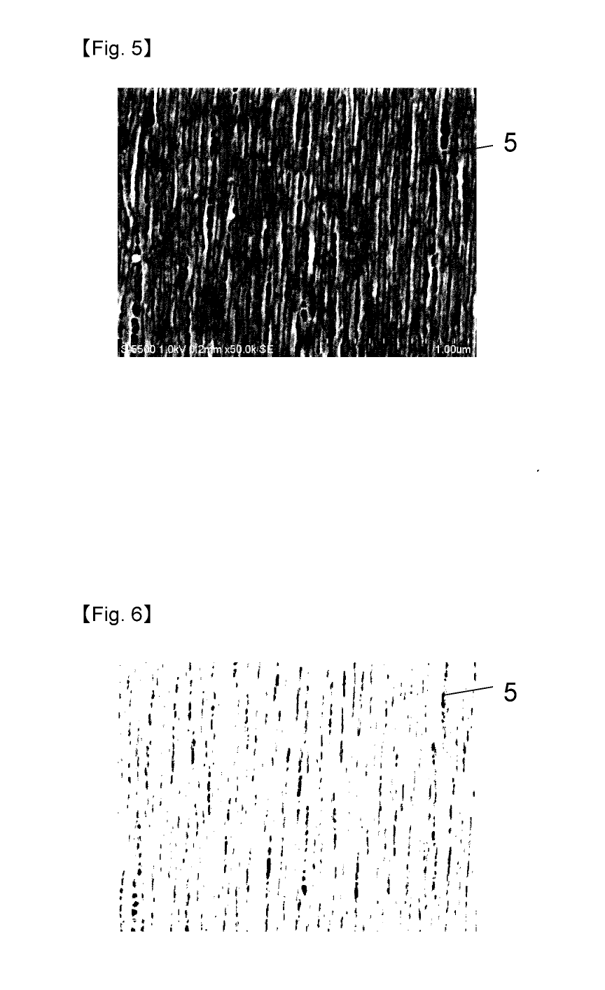

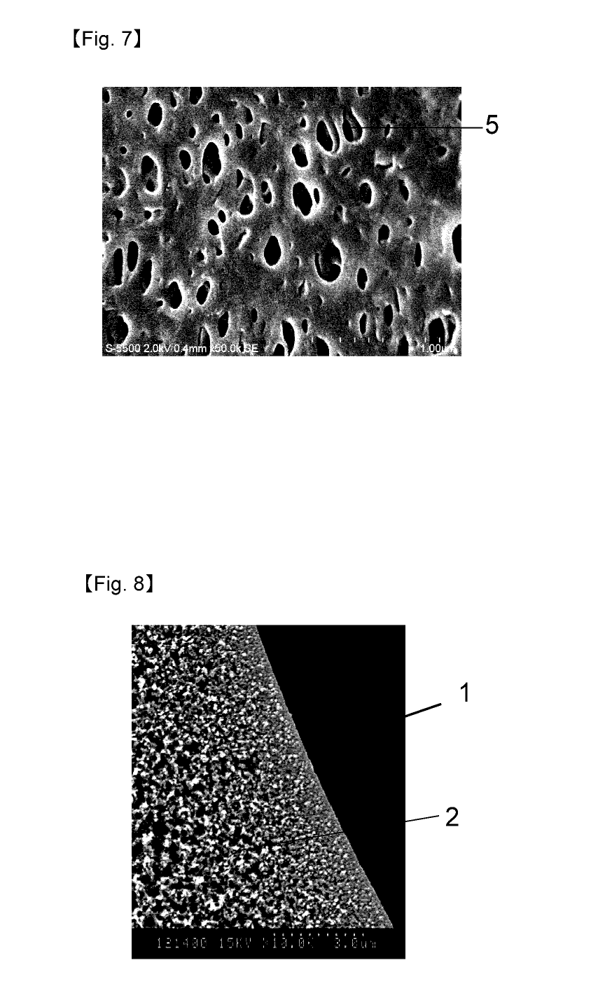

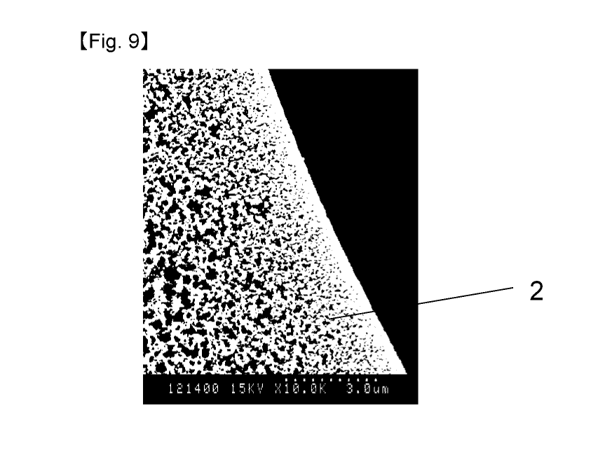

As shown in FIG. 1, the structure of a cross section of the membrane in the thickness direction was an integral structure in which pore diameters varied continuously and in which the pore diameters increased from the inner surface toward the outer surface to have at least one maximum value and then decreased. As shown in FIGS. 5 and 7, the average pore shorter-axis diameter in the inner surface was smaller than that in the outer surface. As shown in FIG. 5, the ratio of the longer-axis diameter to the shorter-axis diameter in the inner surface was large and the opening ratio was small. As shown in FIGS. 2 to 4, the dense layer (I) provided on the outer surface side was thick, and contained pores each having a pore diameter of 100 to 130 nm inclusive. As shown in FIGS. 8 to 9, the porosity in the vicinity of the inner surface was small. The overall porosity of the porous membrane was small, the dense layer (II) provided in the inner surface was thick, and contained pores each having a pore diameter of 100 to 130 nm inclusive, and the maximum pore diameter in the cross section of the membrane in the thickness direction was small. In the test on virus-removing performance, filtration was carried out from the side of the outer surface having a larger average pore shorter-axis diameter toward the side of the inner surface having a smaller average pore shorter-axis diameter. The porous membrane exhibited high virus-removing performance even under a water pressure as high as 50 kPa, and also exhibited high water permeability and high pressure resistance.

### Example 2

An experiment was carried out in the same manner as in Example 1, except that the length of the dry unit was set to 150 mm and the membrane formation stock solution was allowed to flow through the dry unit for 0.23 seconds.

The porous membrane was subjected to the measurement of water permeability, the measurement of virus-removing performance, the measurement of pore shorter-axis diameters in surface, the measurement of opening ratio of surface, the measurement of thickness of dense layer, the elementary analysis, the measurement of pore diameters on cross section, the measurement of porosity in part extending to depth of 3 μm from surface as observed in cross-sectional direction, the measurement of overall porosity of porous membrane, and the pressure resistance test. The results are shown in Table 1.

Similar to the porous membrane produced in Example 1, the porous membrane exhibited high virus-removing performance even under a water pressure as high as 50 kPa, and also exhibited high water permeability and high pressure resistance.

### Example 3

An experiment was carried out in the same manner as in Example 1, except that the length of the dry unit was set to 210 mm and the membrane formation stock solution was allowed to flow through the dry unit for 0.23 seconds.

The porous membrane was subjected to the measurement of water permeability, the measurement of virus-removing performance, the measurement of pore shorter-axis diameters in surface, the measurement of opening ratio of surface, the measurement of thickness of dense layer, the elementary analysis, the measurement of pore diameters on cross section, the measurement of porosity in part extending to 3 μm from surface as observed in cross-sectional direction, the measurement of overall porosity of porous membrane, and the pressure resistance test. The results are shown in Table 1.

Similar to the porous membrane produced in Example 1, the porous membrane exhibited high virus-removing performance even under a water pressure as high as 50 kPa, and also exhibited high water permeability and high pressure resistance.

### Example 4

An experiment was carried out in the same manner as in Example 1, except that, in the composition of the membrane formation stock solution, polysulfone (manufactured by Solvay Corp., Udel polysulfone (registered trade mark) P-3500) (22 parts by weight) and polyvinylpyrrolidone (manufactured by BASF, K30, weight average molecular weight: 40000) (11 parts by weight) were changed to N,N′-dimethylacetamide (66 parts by weight) and water (1 part by weight) and the composition of the injection solution was changed to N,N′-dimethylacetamide (68 parts by weight) and water (32 parts by weight).

The porous membrane was subjected to the measurement of water permeability, the measurement of virus-removing performance, the measurement of pore shorter-axis diameters in surface, the measurement of opening ratio of surface, the measurement of thickness of dense layer, the elementary analysis, the measurement of pore diameters on cross section, the measurement of porosity in part extending to depth of 3 μm from surface as observed in cross-sectional direction, the measurement of overall porosity of porous membrane, and the pressure resistance test. The results are shown in Table 1.

Similar to the porous membrane produced in Example 1, the porous membrane exhibited high virus-removing performance even under a water pressure as high as 50 kPa, and also exhibited high water permeability and high pressure resistance.

### Example 5

An experiment was carried out in the same manner as in Example 1, except that the outer diameter and the inner diameter of the circular slit of the double annular cylindrical spinneret were 0.48 mm and 0.23 mm, respectively. The draft ratio was 1.8. The porous membrane was subjected to the measurement of water permeability, the measurement of virus-removing performance, the measurement of pore shorter-axis diameters in surface, the measurement of opening ratio of surface, the measurement of thickness of dense layer, the elementary analysis, the measurement of pore diameters on cross section, the measurement of porosity in part extending to depth of 3 μm from surface as observed in cross-sectional direction, the measurement of overall porosity of porous membrane, and the pressure resistance test. The results are shown in Table 1.

Similar to the porous membrane produced in Example 1, the porous membrane exhibited high virus-removing performance even under a water pressure as high as 50 kPa, and also exhibited high water permeability and high pressure resistance.

### Comparative Example 1

An experiment was carried out in the same manner as in Example 1, except that the length of the dry unit was set to 400 mm and the membrane formation stock solution was allowed to flow through the dry unit for 0.60 seconds.

The porous membrane was subjected to the measurement of water permeability, the measurement of virus-removing performance, the measurement of pore shorter-axis diameters in surface, the measurement of opening ratio of surface, the measurement of thickness of dense layer, the elementary analysis, the measurement of pore diameters on cross section, the measurement of porosity in part extending to depth of 3 μm from surface as observed in cross-sectional direction, the measurement of overall porosity of porous membrane, and the pressure resistance test. The results are shown in Table 1.

The porous membrane had a fine pore structure of both sides. However, the dense layer on the outer surface side was thin and the opening ratio in the surface of the side where the surface has a smaller average pore shorter-axis diameter was high. Therefore, the porous membrane exhibited poor virus-removing performance under a water pressure as high as 50 kPa.

### Comparative Example 2

Polysulfone (manufactured by Solvay Corp., Udel polysulfone (registered trade mark) P-3500) (16 parts by weight), polyvinylpyrrolidone (manufactured by BASF, K30, weight average molecular weight: 40000) (3.5 parts by weight) and polyvinylpyrrolidone (manufactured by BASF, K90, weight average molecular weight: 1200000) (2.5 parts by weight) were added to a mixed solvent composed of N,N′-dimethylacetamide (77 parts by weight) and water (1 part by weight), and the resultant mixture was heated at 90° C. for 6 hours to dissolved the components, thereby producing a membrane formation stock solution. The membrane formation stock solution was discharged through a circular slit of a double annular cylindrical spinneret. The outer diameter and the inner diameter of the circular slit were 0.35 mm and 0.25 mm, respectively. As an injection solution, a solution composed of N,N′-dimethylacetamide (64 parts by weight) and water (36 parts by weight) was discharged through an inner tube. The spinneret was kept at 50° C. The discharged membrane formation stock solution was allowed to flow through a dry unit (400 mm), in which a gas having a dew point of 26° C. (temperature: 30° C., humidity: 80%) was allowed to flow at an air flow rate of 2.1 m/s, for 0.8 seconds, and was then introduced into a coagulation bath containing N,N′-dimethylacetamide (95 parts by weight) and water (5 parts by weight) at 40° C. to coagulate the stock solution. The coagulated product was washed with water at 50° C., and was then wound at a speed of 40 m/min to form a skein. The draft ratio was 1.6. The resultant product was cut in a 20-cm piece in the length direction, and the piece was washed with hot water at 80° C. for 5 hours, and was then heated at 100° C. for 2 hours. The amount of discharge of the stock solution and the amount of discharge of the injection solution were controlled, so that a porous membrane having the form of a hollow fiber membrane which had a fiber inner diameter of 200 m and a thickness of 40 μm after heat treatment was produced.

The porous membrane was subjected to the measurement of water permeability, the measurement of virus-removing performance, the measurement of pore shorter-axis diameters in surface, the measurement of opening ratio of surface, the measurement of thickness of dense layer, the elementary analysis, the measurement of pore diameters on cross section, the measurement of porosity in part extending to depth of 3 from surface as observed in cross-sectional direction, the measurement of overall porosity of porous membrane, and the pressure resistance test. The results are shown in Table 1.

The porous membrane had a small thickness and a small (thickness)/(inner diameter) ratio, and therefore had poor pressure resistance and was crushed at 400 kPa.

The porous membrane did not have a fine pore structure at both sides and had poor virus-removing performance under a water pressure as high as 50 kPa, because the time for passing through the dry unit was long and the thickness of the porous membrane was thin.

### Comparative Example 3

An experiment was carried out in the same manner as in Comparative Example 2, except that the thickness and the inner diameter of the porous membrane were 70 μm and 200 μm, respectively. The draft ratio was 0.7.

The porous membrane was subjected to the measurement of water permeability, the measurement of virus-removing performance, the measurement of pore shorter-axis diameters in surface, the measurement of opening ratio of surface, the measurement of thickness of dense layer, the elementary analysis, the measurement of pore diameters on cross section, the measurement of porosity in part extending to depth of 3 μm from surface as observed in cross-sectional direction, the measurement of overall porosity of porous membrane, and the pressure resistance test. The results are shown in Table 1.

The pressure resistance of the porous membrane was improved by increasing the thickness and the (thickness)/(inner diameter) ratio of the porous membrane. The porous membrane had a fine pore structure at both sides by increasing the thickness of the porous membrane. However, since the time for allowing passing through the dry unit was long, the dense layers were thin and the virus-removing performance of the porous membrane was poor under a high water pressure. Because of a small draft ratio, the porous membrane had such a membrane structure that the ratio of the longer-axis diameter to the shorter-axis diameter was small. Therefore, the water permeability did not increase although the virus-removing performance under a low pressure was poor. Thus, the porous membrane exhibited poor water permeability that was not in correlate to its virus-removing performance.

TABLE 1

| | | | Example 1 | Example 2 | Example 3 | Example 4 | Example 5 |
|---|---|---|---|---|---|---|---|
| Thickness | | μm | 90 | 90 | 90 | 90 | 90 |
| Thickness/inner diameter | | — | 0.48 | 0.48 | 0.48 | 0.48 | 0.48 |
| Porosity | | % | 69 | 66 | 67 | 64 | 67 |
| Cross section | Fine pore structure of | | Presence | Presence | Presence | Presence | Presence |
| | both sides | | | | | | |
| | Integral structure | | Presence | Presence | Presence | Presence | Presence |
| | Largest pore diameter | μm | 1.1 | 0.8 | 1.7 | 0.9 | 1.2 |
| | Thickness of dense layer | μm | 3.2 | 5.7 | 4.2 | 4.2 | 3.5 |
| | (I) on outer surface side | | | | | | |
| | (side of surface having | | | | | | |
| | larger shorter-axis | | | | | | |
| | diameter) | | | | | | |
| | Presence or absence of | | Presence | Presence | Presence | Presence | Presence |
| | pores each having pore | | | | | | |
| | diameter of 100 to 130 nm | | | | | | |
| | inclusive in dense layer | | | | | | |
| | (I) | | | | | | |
| | Thickness of dense layer | μm | 3.7 | 3.5 | 3.5 | 3.0 | 3.3 |
| | (II) on inner surface | | | | | | |
| | side (side of surface | | | | | | |
| | having smaller shorter- | | | | | | |
| | axis diameter) | | | | | | |
| | Presence or absence of | | Presence | Presence | Presence | Presence | Presence |
| | pores each having pore | | | | | | |
| | diameter of 100 to 130 nm | | | | | | |
| | inclusive in dense layer | | | | | | |
| | (II) | | | | | | |
| | Porosity in part extending | % | 23.3 | 27.7 | 14.1 | 26.8 | 24.1 |
| | to depth of 3 μm from | | | | | | |
| | inner surface side | | | | | | |
| Inner surface | Average shorter-axis diameter | nm | 15 | 11 | 17 | 11 | 13 |
| (side of surface | Shorter-axis diameter | nm | 10 | 7 | 10 | 4 | 4 |
| having smaller | standard deviation | | | | | | |
| shorter-axis | longer-axis diameter/ | — | 6.2 | 4.6 | 4.0 | 3.1 | 3.3 |
| diameter) | shorter-axis diameter | | | | | | |
| | Opening ratio | % | 9.7 | 8.9 | 6.6 | 3.9 | 0.9 |
| Outer surface | Average shorter-axis diameter | nm | 140 | 133 | 133 | 125 | 135 |
| (side of surface | | | | | | | |
| having larger | | | | | | | |
| shorter-axis | | | | | | | |
| diameter) | | | | | | | |
| Performance | Water permeability | ml/Pa/ | 2.8 | 2.7 | 3.1 | 0.4 | 1.2 |
| | | hr/m² | | | | | |
| | Virus-removing | LRV | 7.0 | 7.0 | 7.0 | 7.0 | 7.0 |
| | performance 7 kPa | | | | | | |
| | Virus-removing | LRV | 7.0 | 6.1 | 5.5 | 5.2 | 6.1 |
| | performance 50 kPa | | | | | | |
| | Virus-removing | LRV | 2.3 | 1.8 | 1.3 | 4.1 | 5.6 |
| | performance 400 kPa | | | | | | |

| | | | | | | |
|---|---|---|---|---|---|---|
| Hydrophilic polymer | mass % | 2.4 | 2.4 | 2.4 | 2.3 | 2.4 |
| Pressure resistance test | | Uncrushed | Uncrushed | Uncrushed | Uncrushed | Uncrushed |

| | | | Comparative | Comparative | Comparative |
|---|---|---|---|---|---|
| | | | Example 1 | Example 2 | Example 3 |
| Thickness | | μm | 90 | 40 | 70 |
| Thickness/inner diameter | | — | 0.48 | 0.20 | 0.35 |
| Porosity | | % | 71 | 83 | 81 |
| Cross section | Fine pore structure of | | Presence | Absence | Absence |
| | both sides | | | | |
| | Integral structure | | Presence | Presence | Presence |
| | Largest pore diameter | μm | 0.6 | 1.3 | 1 |
| | Thickness of dense layer | μm | 0.1 | 0 | 0 |
| | (I) on outer surface side | | | | |
| | (side of surface having | | | | |
| | larger shorter-axis | | | | |
| | diameter) | | | | |
| | Presence or absence of | | Presence | — | — |
| | pores each having pore | | | | |
| | diameter of 100 to 130 nm | | | | |
| | inclusive in dense layer | | | | |
| | (I) | | | | |
| | Thickness of dense layer | μm | 3.5 | 3.9 | 3.8 |
| | (II) on inner surface side | | | | |
| | (side of surface having | | | | |
| | smaller shorter-axis | | | | |
| | diameter) | | | | |
| | Presence or absence of | | Presence | Presence | Presence |
| | pores each having pore | | | | |
| | diameter of 100 to 130 nm | | | | |
| | inclusive in dense layer | | | | |
| | (II) | | | | |
| | Porosity in part extending | % | 22.5 | 39.1 | 37.5 |
| | to depth of 3 μm from | | | | |
| | inner surface side | | | | |
| Inner surface | Average shorter-axis diameter | nm | 18 | 19 | 20 |
| (side of surface | Shorter-axis diameter | nm | 14 | 9 | 9 |
| having smaller | standard deviation | | | | |
| shorter-axis | longer-axis diameter/ | — | 3.8 | 3.3 | 2.0 |
| diameter) | shorter-axis diameter | | | | |
| | Opening ratio | % | 13.6 | 1.5 | 1.3 |
| Outer surface | Average shorter-axis diameter | nm | 354 | 429 | 443 |
| (side of surface | | | | | |
| having larger | | | | | |
| shorter-axis | | | | | |
| diameter) | | | | | |
| Performance | Water permeability | ml/Pa/ | 6.8 | 4.0 | 3.8 |
| | | hr/m² | | | |
| | Virus-removing | LRV | 7.0 | 7.0 | 4.5 |
| | performance 7 kPa | | | | |
| | Virus-removing | LRV | 0.9 | 0.1 | 0.5 |
| | performance 50 kPa | | | | |
| | Virus-removing | LRV | 0.0 | 0.0 | 0.0 |
| | performance 400 kPa | | | | |

| | | | | |
|---|---|---|---|---|
| Hydrophilic polymer | mass % | 2.4 | 3 | 3.4 |
| Pressure resistance test | | Uncrushed | Crushed | Uncrushed |

### REFERENCE SIGNS LIST

1: Hollow fiber membrane
2: Pore in cross section of hollow fiber membrane
3: Pore having pore diameter of 130 nm or more in cross section of hollow fiber membrane
4: Dense layer
5: Pore in surface of hollow fiber membrane

1. A porous membrane having properties below:
(A-1) an average pore shorter-axis diameter in one surface is smaller than that in another surface;
(A-2) in a cross section of the membrane in the thickness direction, pore diameters increase from the one surface toward the other surface to have at least one maximum value and then decrease;
(A-3) the porous membrane has a layer of a layer which is provided on a side of a surface having a larger average pore shorter-axis diameter and which has pore diameters of 130 nm or less, the layer extending in the thickness direction from the surface, wherein a thickness of the layer is 0.5 to 20 μm inclusive; and
(A-4) the layer has pores each having a pore diameter of 100 to 130 nm inclusive.

2. The porous membrane according to claim 1, wherein the porous membrane further has a property below:
(A-5) the average pore shorter-axis diameter is 10 to 50 nm inclusive in a surface of a side where the average pore shorter-axis diameter is small.

3. The porous membrane according to claim 1, wherein the porous membrane further has a property below:
(A-6) an average pore longer-axis diameter in the surface of the side where the surface has a smaller average pore shorter-axis diameter is 2.5 times or more larger than the average pore shorter-axis diameter in the surface of the side where the surface has a smaller average pore shorter-axis diameter.

4. The porous membrane according to claim 1, wherein the porous membrane further has properties below:
(A-7) the porous membrane has a layer which is provided on the side of the surface having a smaller average pore shorter-axis diameter and which has pore diameters of 130 nm or less, the layer extending from the surface, wherein a thickness of the layer is 0.3 to 20 μm inclusive; and
(A-8) the layer has pores each having a pore diameter of 100 to 130 nm inclusive.

5. The porous membrane according to claim 1, wherein the porous membrane further has a property below:
(A-9) in a cross section of the membrane in the thickness direction, a part extending to a thickness of 3 μm from the surface of the side where the surface has a smaller average pore shorter-axis diameter has a porosity of 5 to 35% inclusive.

6. The porous membrane according to claim 1, wherein the porous membrane further has a property below:
(A-10) the surface of the side where the surface has a smaller average pore shorter-axis diameter has an opening ratio of 0.7 to 12% inclusive.

7. The porous membrane according to claim 1, wherein the porous membrane further has a property below:
(A-11) an overall porosity of the porous membrane is 60 to 90% inclusive.

8. The porous membrane according to claim 1, wherein the porous membrane further has a property below:
(A-12) a maximum pore diameter in the cross section of the membrane in the thickness direction is 10 μm or less.

9. (canceled)

10. (canceled)

11. (canceled)

12. (canceled)

13. A method for purifying water, comprising the step of allowing water to permeate the porous membrane according to claim 1 from a side of a surface having a larger average pore shorter-axis diameter toward a side of a surface having a smaller average pore shorter-axis diameter.

14. A porous membrane having properties below:
(B-1) an average pore shorter-axis diameter in one surface is smaller than that in another surface;
(B-2) an average pore longer-axis diameter in a surface of a side where the surface has a smaller average pore shorter-axis diameter is 2.5 times or more larger than an average pore shorter-axis diameter in the surface of the side where the surface has a smaller average pore shorter-axis diameter;
(B-3) in a cross section of the membrane in the thickness direction, a part extending to a thickness of 3 μm from the surface of the side where the surface has a smaller average pore shorter-axis diameter has a porosity of 5 to 35% inclusive; and
(B-4) the surface of the side where the surface has a smaller average pore shorter-axis diameter has an opening ratio of 0.7 to 12% inclusive.

15. The porous membrane according to claim 14, wherein the porous membrane further has properties below:
(B-5) in a cross section of the membrane in the thickness direction, pore diameters increase from the one surface toward the other surface to have at least one maximum value and then decrease;
(B-6) the porous membrane has a layer which is provided on a side of a surface having a larger average pore shorter-axis diameter and which has pore diameters of 130 nm or less, the layer extending in the thickness direction from the surface, wherein a thickness of the layer is 0.5 to 20 μm inclusive; and
(B-7) the layer has pores each having a pore diameter of 100 to 130 nm inclusive.

16. The porous membrane according to claim 14, wherein the porous membrane further has a property below:
(B-8) the average pore shorter-axis diameter is 10 to 50 nm inclusive in a surface of a side where the average pore shorter-axis diameter is small.

17. The porous membrane according to claim 14, wherein the porous membrane further has properties below:
(B-9) the porous membrane has a layer which is provided on the side of the surface having a smaller average pore shorter-axis diameter and which has pore diameters of 130 nm or less, the layer extending from the surface, wherein the thickness of the layer is 0.3 to 20 μm inclusive; and
(B-10) the layer has pores each having a pore diameter of 100 to 130 nm inclusive.

18. The porous membrane according to claim 14, wherein the porous membrane further has a property below:
(B-11) an overall porosity of the porous membrane is 60 to 90% inclusive.

19. The porous membrane according to claim 14, wherein the porous membrane further has a property below:
(B-12) a maximum pore diameter in the cross section of the membrane in the thickness direction is 10 μm or less.

20. (canceled)

21. (canceled)

22. (canceled)

23. (canceled)

24. A method for purifying water, comprising the step of allowing water to permeate the porous membrane according to claim 15 from a side of a surface having a larger average pore shorter-axis diameter toward a side of a surface having a smaller average pore shorter-axis diameter.

25. The porous membrane according to claim 1, wherein the porous membrane is used for a virus-removing purpose.

26. A water purifier including the porous membrane according to claim 1.

27. The water purifier according to claim 26, wherein a raw water flow path is disposed on the side of the surface having a larger average pore shorter-axis diameter, and a permeated water flow path is disposed on the side of the surface having a smaller average pore shorter-axis diameter.
